(19) United States
(12) Patent Application Publication
(10) Pub. No.: US 2025/0339851 A1
(43) Pub. Date: Nov. 6, 2025

(54) FIBER REINFORCEMENT FOR ION EXCHANGE COMPOSITE MEMBRANE

(71) Applicant: SOLVAY SPECIALTY POLYMERS ITALY S.P.A., Bollate (Milano) (IT)

(72) Inventors: Claudio Oldani, Parabiago (MI) (IT); Stefano Tonella, Corbetta (MI) (IT)

(73) Assignee: SOLVAY SPECIALTY POLYMERS ITALY S.P.A., Bollate (Milano) (IT)

(21) Appl. No.: 18/870,247

(22) PCT Filed: May 26, 2023
(86) PCT No.: PCT/EP2023/064182

§ 371 Date: Nov. 27, 2024

(30) Foreign Application Priority Data
Jun. 1, 2022 (EP) 22176660.3

(51) Int. Cl. B01J 47/127; B01D 61/14; B01D 69/02; B01D 69/12; B01D 71/36; B01D 71/40; B01D 71/64; B01J 41/05; B01J 41/14; C08J 5/22; C08L 79/08; D01F 6/90; D04H 1/4334; H01M 8/10; H01M 8/1023; H01M 8/103; H01M 8/1039

(52) U.S. Cl. CPC B01J 47/127; B01D 69/02; B01D 69/12; B01D 71/36; B01D 71/40; B01D 71/641; B01J 41/05; B01J 41/14; C08J 5/2281; C08J 5/2293; C08L 79/08; D01F 6/90; D04H 1/4334; H01M 8/1023; H01M 8/103; H01M 8/1039; B01D 61/145; B01D 2325/42; C08J 2379/08; C08J 2427/18; C08L 2203/12; D10B 2505/04; H01M 2008/1095

(57) ABSTRACT

Disclosed are fibers comprising a composition comprising a fluorinated polymer comprising a plurality of ion exchange groups or a precursor thereof and an aromatic polyamide-imide polymer. The fibers are obtained by electrospinning or forcespinning a composition comprising a fluorinated polymer comprising a plurality of ion exchange groups or a precursor thereof and an aromatic polyamide-imide polymer. The fibers can be arranged into webs suitable for the preparation of composite membranes. In particular composite ion exchange membranes suitable for use in proton exchange fuel cells or filtration devices.

### TECHNICAL FIELD

The present invention relates to fibers, to fiber materials comprising webs of fibers, as well as to polymer electrolyte membranes comprising said fiber materials. The polymer electrolyte membranes of the invention are particularly suitable for use in electrochemical devices, such as fuel cells.

### BACKGROUND ART

Proton exchange fuel cells are electrochemical devices that produce electricity by the catalyzed combination of a fuel which is hydrogen and an oxidant, such as oxygen. In a typical proton exchange fuel cell, the polymer electrolyte membrane is responsible for the proton conductivity that allows the transport of protons from the anode to the cathode, constituting the essential component of the electrochemical device. Polymer electrolyte membranes used for the proton exchange fuel cell are required to have superior proton conductivity, superior capability to separate hydrogen gas supplied to the anode and oxygen supplied to the cathode, and excellent mechanical strength, shape stability and chemical resistance. To improve properties such as dimensional stability, durability and mechanical strength reinforced composite membrane are known, which comprise an ion exchange polymer, as an electrolyte substance, and a porous support. Well known in the art are reinforced composite membranes comprising a porous polytetrafluoroethylene support and a perfluorinated polymer comprising ion exchange groups.

Examples of perfluorinated polymers comprising ion exchange groups are for instance copolymers of tetrafluoroethylene and a comonomer comprising —SO₃M functional groups such as:

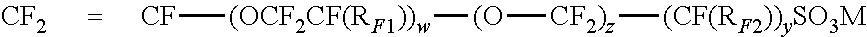

wherein w is 0, 1 or 2, R_{F1} and R_{F2}, equal or different from each other, are independently selected from F, Cl or a C₁-C₁₀ fluoroalkyl group, optionally substituted with one or more ether oxygens, z is 0 or 1, y is an integer from 0 to 6; and M is H, Li, Na, K or a quaternary ammonium ion.

For fuel cell applications, well-known impregnated membranes comprise a perfluorinated ion exchange polymer impregnated into an expanded PTFE (ePTFE) support.

The search for alternative support to expanded PTFE (ePTFE) in reinforced membranes for fuel cells has attracted increasing interest. To this aim, aromatic polymers are promising candidates thanks to their mechanical properties but their use is hampered by the poor compatibility with the perfluorinated ion exchange polymer, leading to the formation of membranes having insufficient water management and poor conductivity, especially at low relative humidity. One of the critical features of a fuel cell comprising a polymer electrolyte membrane (hereinafter “PEMFC”) is to maintain a high water-content in the membrane to assure acceptable ion conductivity, therefore water management in the membrane is critical for efficient performances. The PEMFC must operate in conditions wherein the by-product water does not evaporate faster than it is produced. The water content of a PEMFC is determined by the balance of water or its transport during the reactive mode of operation. Water-transport processes are a function of the current and the properties of both the membrane and the electrodes (permeability, thickness, etc.).

Nanofibers constitute a class of known fillers used in the fabrication of reinforced composite membranes. These nanofibrous structured materials may increase water retention and, consequently, the proton conductivity of the membrane.

Electrospinning is a versatile method for generating ultrathin nanofiber-based architectures. The morphology and diameter of electrospun fibers can be tuned by controlling different parameters, which include the intrinsic properties of the solution, such as the type of polymer, viscosity, concentration, elasticity, and surface tension of the solvent, among others, but also the operational conditions, such as the electric field applied in the process, the distance between spinneret and collector, and the feeding rate for the polymeric solution.

The use of electrospun nanofibers in composite membranes of perfluorinated ion exchange polymer, such as Nafion®, Fumion®, and Aquivion® PFSA, has been studied over the last 15 years. For instance Ballengee, J. B et al., Macromolecules 2011, 44, 18, 7307-7314, disclosed two distinct membrane structures: (1) a Nafion® film reinforced by a poly(phenyl sulfone) nanofiber network and (2) Nafion® nanofibers embedded in inert/uncharged poly(phenyl sulfone) polymer nanofiber network. Both membrane structures exhibit similar volumetric/gravimetric water swelling and proton conductivity, where the conductivity scales linearly with Nafion® volume fraction and the swelling is less than expected based on the relative amounts of Nafion®.

WO2012/174463A1 similarly discloses composite membranes comprising a non-woven web of material comprising fibers consisting of one or more fully aromatic polyimide polymer and an ion exchange polymer impregnated between the opposing surfaces of the composite membrane. In an exemplary embodiment, a composite membrane is disclosed comprising a web made of polyimide polymer, comprising PMDA-ODA recurring units, and an ion exchange polymer obtained by the hydrolysis of a tetrafluorethylene/perfluoro-5-sulfonylfluoride-3-oxa-1-pentene copolymer having an equivalent weight of 737. The composite membrane exhibits lower conductivity than the ion exchange polymer alone but lower swelling.

Perfluorinated ion exchange polymers such as Nafion®, and short-side-chain Aquivion® PFSA, 3M ionomers, etc., owing to the electrostatic interactions that result from their chemical structure tend to electrospray as beads rather than electrospin into fibres. The addition of a high molecular weight carrier polymer and the increase of the ion exchange polymer concentration in dispersion are means to overcome this situation. Several carrier polymers, such as poly(ethylene oxide), poly(vinyl pyrrolidone) or poly(acrylic acid), have been used to facilitate the electrospinning of ion exchange polymers.

US20160322661A discloses a membrane for a proton exchange membrane fuel cell comprising, by weight with respect to the total weight of the membrane: from 50 to 95% of a cation exchange fluorinated polymer; and from 5 to 50% of a hydrocarbon aromatic polymer different from the cation exchange fluorinated polymer, and comprising at least one aromatic ring on its polymer chain and comprising sulfonic acid groups. US20160322661A does not disclose compositions comprising aromatic polymers free of sulfonic acid groups nor fibers prepared from the same.

It has now been found that it is possible to obtain composite fibers comprising both an aromatic polymer and a fluorinated ion exchange polymer overcoming many of the issues encountered in the prior art.

In particular it has been found that fibers can be spun from compositions comprising aromatic polyamide-imide polymers and fluorinated ion exchange polymers which are characterised by good mechanical properties. The composite fibers allow obtaining supports which are characterised by good conductivity at low relative humidity and can therefore be successfully used in the preparation of ion exchange membranes.

### SUMMARY OF INVENTION

A first object of the invention are fibers comprising a composition comprising a fluorinated polymer comprising a plurality of ion exchange groups or a precursor thereof and an aromatic polyamide-imide polymer. The fibers may be advantageously arranged into webs of fibers. The inventive fibers are prepared from a composition comprising at least one fluorinated polymer comprising a plurality of ion exchange groups or a precursor thereof, and at least one aromatic polyamide-imide polymer. The composition is also an object of the invention.

A second object of the invention is a process for the preparation of the fibers comprising electrospinning or forcespinning a composition comprising a fluorinated polymer comprising a plurality of ion exchange groups or a precursor thereof and an aromatic polyamide-imide polymer.

A third object of the invention are composite membranes comprising the fibers of the first object, which may be advantageously arranged into a web of fibers or mat, and a fluorinated polymer comprising a plurality of ion exchange groups. The fibers may be either distributed within a matrix of the fluorinated polymer comprising a plurality of ion exchange groups. Alternatively when said fibers are arranged into a web or mat, the fluorinated polymer comprising a plurality of ion exchange groups may be impregnated between the opposing surfaces of said web or mat.

Among further objects of the invention are fuel cells or filtration devices comprising the composite membrane.

### BRIEF DESCRIPTION OF DRAWINGS

FIG. 1: In-plane conductivity vs. relative humidity of composite membranes of Example 2 and Comp. Example 2

### DESCRIPTION OF INVENTION

As used herein, the singular forms “a”, “an” and “the” are intended to include the plural forms as well, unless the context clearly indicates otherwise. As used herein, “plurality” means two or more.

The use of parentheses before and after symbols or numbers identifying compounds, chemical formulae or parts of formulae has the mere purpose of better distinguishing those symbols or numbers from the rest of the text and hence said parentheses can also be omitted.

Any description, even though described in relation to a specific embodiment, is applicable to and interchangeable with other embodiments of the present invention.

Any recitation herein of numerical ranges by endpoints includes all numbers subsumed within the recited ranges as well as the endpoints of the range and equivalents.

As used herein, the expressions “ion exchange polymer” or “ionomer” generally refer to a polymer that conducts ions. More precisely, the expressions interchangeably refer to a polymer comprising a plurality of ion exchange groups.

A first object of the invention is a fiber comprising a composition, [Composition (C)], comprising at least one fluorinated polymer comprising a plurality of ion exchange groups or a precursor thereof, collectively referred to as [Polymer (Iₓ)], and at least one aromatic polyamide-imide polymer, hereinafter referred to as [Polymer (PAI)].

For the avoidance of doubt, the composition comprises one or more than one Polymer (Iₓ) and one or more than one Polymer (PAI).

Composition (C) typically comprises 0.1 to 95.0 wt %, 0.5 to 75.0 wt %, of Polymer (Iₓ) with respect to the total weight of the composition. Composition (C) may comprise at least 1.0 wt %, preferably at least 2.0 wt % of Polymer (Iₓ). Polymer (Iₓ) may be at most 60.0 wt %, at most 50.0 wt %, at most 49.5 wt %, at most 45.0 wt %, even at most 30.0 wt %, or at most 25.0 wt % of the total weight of the composition.

The composition comprises 5.0 to 99.9 wt %, preferably 25.0 to 99.5 wt %, of Polymer (PAI) with respect to the total weight of the composition. Typically, Polymer (PAI) is at least 40.0 wt %, at least 50.0 wt %, at least 50.5 wt %, even at least 55.0 wt %, preferably at least 60.0 wt %, even at least 75 wt % with respect to the total weight of the composition.

In certain embodiments Composition (C) comprises 0.01 to 5.0 wt % of a stabilizing additive with respect to the total weight of the composition.

In one aspect of said embodiment the stabilizing additive is a compound capable to decompose peroxide radicals. Said peroxide decomposition additive may suitably be selected from the group consisting of: alumina, silica, ceria (CeO₂), Ce₂O₃, titania (TiO₂), Ti₂O₃, zirconium oxide, manganese dioxide, yttrium oxide (Y₂O₃), Fe₂O₃, FeO, tin oxide, germania, copper oxide, nickel oxide, manganese oxide, tungsten oxide, and mixtures thereof. Alternatively the peroxide decomposition additive may be selected from the salts of the same metals, in particular salts of manganese or cerium. The salt may comprise any suitable anion, including chloride, bromide, nitrate, carbonate and the like.

Advantageously the peroxide decomposition additive is selected from the group consisting of the oxides of cerium and manganese, CeO₂, Ce₂O₃ and MnO₂, alone or in combination with other oxides, such as silica or alumina, and of the salts of cerium and manganese.

The peroxide decomposition additive is mixed well with or dissolved within the composition to achieve substantially uniform distribution.

Composition (C) may advantageously comprise 0.5 to 75.0 wt % of Polymer (Iₓ), 25.0 to 99.5 wt %, of Polymer (PAI) and optionally 0.01 to 5.0 wt % of a stabilizing additive as above defined, with respect to the total weight of the composition.

Composition (C) may comprise 1.0 to 50.0 wt %, 1.0 to 49.5 wt %, 1.0 to 45.0 wt %, even 1.0 to 25.0 wt %, of Polymer (Iₓ), 50.0 to 99.0 wt %, 50.5 to 99.0 wt %, 55.0 to 99.0 wt %, preferably 75.0 to 99.0 wt % of Polymer (PAI), and, optionally, 0.01 to 5.0 wt % of a stabilizing additive with respect to the total weight of the composition. The stabilizing additive is preferably selected from the group consisting of the oxides of cerium and manganese, CeO₂, Ce₂O₃ and MnO₂, alone or in combination with other oxides, such as silica or alumina, and of the salts of cerium and manganese.

Advantageously, the composition essentially consists, preferably consists, of Polymer (Iₓ), Polymer (PAI) and optionally a stabilizing additive as detailed above. The expression “essentially consists” when referred to the composition indicates that the amount of other components besides Polymer (Iₓ), Polymer (PAI) and the optional stabilizing additive is not more than 10.0 wt %, preferably not more than 5.0 wt %, more preferably not more than 1.0 wt % with respect to the total weight of the composition.

### The Fluorinated Polymer Comprising Ion Exchange Groups and its Precursor [Polymer (I_{X})]

The expression [Polymer (I_{X})] is used herein to collectively refer to a fluorinated polymer comprising a plurality of ion exchange groups as well as to its precursor which comprises a plurality of functional groups which may be hydrolysed to generate ion exchange groups.

Polymer (I_{X}), is fluorinated, that is to say it comprises recurring units derived from ethylenically unsaturated monomers comprising at least one fluorine atom. It may further comprise recurring units derived from at least one hydrogenated monomer, wherein the term “hydrogenated monomer” is intended to denote an ethylenically unsaturated monomer comprising at least one hydrogen atom and free from fluorine atoms.

Polymer (I_{X}) comprises a plurality of ion exchange groups selected from the group consisting of —SO₃M, —PO₃M and —COOM, wherein M is selected from the group consisting of H, an ammonium group or a metal, preferably a monovalent metal. As examples of preferred monovalent metals mention can be made of alkali metals, preferably Li, K, Na.

The precursor to Polymer (Iₓ), comprises a plurality of hydrolysable groups selected from the group consisting of —SO₂X′, —PO₂X″ and —COX″, wherein X′ is a halogen, in particular F or Cl and X″ is —OR and R is a C1-C5 alkyl group.

In a preferred embodiment Polymer (Iₓ) comprises functional groups —SO₂X.

Polymer (Ix) may be in the neutral form, wherein the expression “neutral form” indicates that it comprises hydrolysable groups —SO₂X wherein X═X′ and X′ is selected from the group consisting of F, Cl, Br, I. Preferably X′ is selected from F or Cl. More preferably X′ is F.

Alternatively, Polymer (Ix) may be in the ionic (acid or salified) form, wherein the expression “ionic form” indicates that in the —SO₂X functional groups X is OM and M is selected from the group consisting of H, alkaline metals, NH₄.

For the avoidance of doubt, the term “alkaline metal” is hereby intended to denote the following metals: Li, Na, K, Rb, Cs. Preferably the alkaline metal is selected from Li, Na, K.

Fluorinated polymers comprising —SO₃M functional groups are typically prepared from fluorinated polymers comprising —SO₂X′ functional groups, preferably —SO₂F functional groups, by methods known in the art.

Polymer (Ix) can be obtained in its salified form, i.e. wherein M is a cation selected from the group consisting of NH₄ and alkaline metals, by treatment of the corresponding polymer comprising —SO₂X′ functional groups, typically —SO₂F functional groups, with a strong base (e.g. NaOH, KOH).

Polymer (Iₓ) can be obtained in its acid form, i.e. wherein M is H, by treatment of the corresponding salified form of the polymer with a concentrated acid solution.

Suitable Polymer (Iₓ) are those polymers comprising recurring units deriving from at least one ethylenically unsaturated fluorinated monomer containing at least one —SO₂X′ functional group (monomer (A) as hereinafter defined) and recurring units deriving from at least one ethylenically unsaturated fluorinated monomer (monomer (B) as hereinafter defined).

The phrase “at least one monomer” is used herein with reference to monomers of both type (A) and (B) to indicate that one or more than one monomer of each type can be present in the polymer. Hereinafter the term monomer will be used to refer to both one and more than one monomer of a given type.

Non limiting examples of suitable monomers (A) are:
sulfonyl halide fluoroolefins of formula: CF₂═CF(CF₂)ₚSO₂X′ wherein p is an integer from 0 to 10, preferably from 1 to 6, more preferably p is equal to 1, 2 or 3, and wherein preferably X′═F;
sulfonyl halide fluorovinylethers of formula: CF₂═CF—O—(CF₂)ₘSO₂X′ wherein m is an integer from 1 to 10, preferably from 1 to 6, more preferably from 2 to 4, even more preferably m equals 2 or 4, and wherein preferably X′═F;
sulfonyl halide fluoroalkoxyvinylethers of formula:

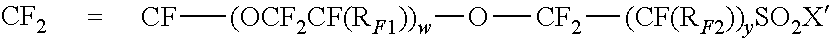

wherein w is 0, 1 or 2, R_{F1} and R_{F2}, equal or different from each other, are independently F, Cl or a C₁-C₁₀ fluoroalkyl group, optionally substituted with one or more ether oxygens, y is an integer from 0 to 6; preferably w is 1, R_{F1} is —CF₃, y is 1 and R_{F2} is F, and wherein preferably X′═F;
sulfonyl halide aromatic fluoroolefins of formula CF₂═CF—Ar—SO₂X′ wherein Ar is a C₅-C₁₅ aromatic or heteroaromatic substituent, and wherein preferably X′═F.

Preferably monomer (A) is selected from the group of the sulfonyl fluorides, i.e. wherein X′═F.

More preferably monomer (A) is selected from the group of the fluorovinylethers of formula CF₂═CF—O—(CF₂)ₘ—SO₂F, wherein m is an integer from 1 to 6, preferably from 2 to 4, more preferably 2 or 4.

Even more preferably monomer (A) is CF₂═CFOCF₂CF₂—SO₂F (perfluoro-5-sulfonylfluoride-3-oxa-1-pentene).

Non limiting examples of suitable ethylenically unsaturated fluorinated monomers of type (B) are:
C₂-C₈ perfluoroolefins, such as tetrafluoroethylene (TFE), hexafluoropropylene (HFP), perfluoroisobutylene;
C₂-C₈ hydrogen-containing fluoroolefins, such as trifluoroethylene (TrFE), vinylidene fluoride (VDF), vinyl fluoride (VF), pentafluoropropylene, and hexafluoroisobutylene;
C₂-C₈ chloro- and/or bromo- and/or iodo-containing fluoroolefins, such as chlorotrifluoroethylene (CTFE) and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluorooxyalkylvinylethers of formula CF₂═CFOX₀, wherein X₀ is a C₁-C₁₂ fluorooxyalkyl group comprising one or more than one ethereal oxygen atom, including notably fluoromethoxyalkylvinylethers of formula CF₂═CFOCF₂OR_{f2}, with R_{f2} being a C₁-C₃ fluoro(oxy)alkyl group, such as —CF₂CF₃, —CF₂CF₂—O—CF₃ and —CF₃
fluorodioxoles, of formula:

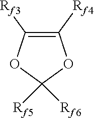

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃.

Preferably monomer (B) is selected among:
C₂-C₈ perfluoroolefins selected from tetrafluoroethylene (TFE) and/or hexafluoropropylene (HFP);
C₂-C₈ hydrogen-containing fluoroolefins, selected from trifluoroethylene (TrFE), vinylidene fluoride (VDF), and vinyl fluoride (VF);
fluorodioxoles, of formula:

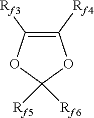

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃; and
mixtures thereof.

End-groups, impurities, defects and other spurious units in limited amount (less than 1 mol %, with respect to total moles of recurring units) may be present in the preferred Polymer (Iₓ), in addition to the listed recurring units, without this affecting substantially the properties of Polymer (Iₓ).

According to certain embodiments, the at least one monomer (B) is TFE.

Preferred Polymers (Iₓ) are selected from polymers comprising:
(1) 50 to 99 mol %, preferably 52 to 98 mol %, with respect to total moles of recurring units of Polymer (Iₓ) of recurring units derived from tetrafluoroethylene (TFE) in an amount of;
(2) 1 to 50 mol %, preferably 2 to 48 mol %, with respect to total moles of recurring units of Polymer (Iₓ) of hydrolysed recurring units comprising at least one —SO₃M group derived from at least one monomer selected from the group consisting of:
(j) sulfonyl halide fluorovinylethers of formula: CF₂═CF—O—(CF₂)ₘSO₂X, with X being a halogen, preferably, F or Cl, more preferably F; wherein m is an integer from 1 to 10, preferably from 1 to 6, more preferably from 2 to 4, even more preferably m equals 2 or 4;
(jj) sulfonyl fluoride fluoroalkoxyvinylethers of formula: CF₂═CF—(OCF₂CF(R_{F1}))_{w}—O—CF₂(CF(R_{F2}))_{y}SO₂X, with X being a halogen, preferably, F or Cl, more preferably F; wherein w is an integer from 0 to 2, R_{F1} and R_{F2}, equal or different from each other, are independently F, Cl or a C₁-C₁₀ fluoroalkyl group, optionally substituted with one or more ether oxygens, y is an integer from 0 to 6; preferably w is 1, R_{F1} is —CF₃, y is 1 and R_{F2} is F; and
(jjj) mixtures thereof; and
(3) 0 to 45 mol %, preferably 0 to 40 mol %, with respect to total moles of recurring units of Polymer (Iₓ), of recurring units derived from at least one hydrogenated and/or fluorinated monomer different from TFE, preferably a perfluorinated monomer, generally selected from the group consisting of hexafluoropropylene, perfluoroalkylvinylethers of formula CF₂═CFOR′_{f1}, wherein R′_{f1} is a C₁-C₆ perfluoroalkyl, e.g. —CF₃, —C₂F₅, —C₃F₇; perfluoro-oxyalkylvinylethers of formula CF₂═CFOR′_{O1}, wherein R′_{O1} is a C₂-C₁₂ perfluoro-oxyalkyl having one or more ether groups, including e.g. perfluoroalkyl-methoxy-vinylethers of formula CF₂═CFOCF₂OR′_{f2} in which R′_{f2} is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃.

Consistently, preferred precursors Polymer (Iₓ) may be obtained are selected from polymers comprising:
(1) 50 to 99 mol %, preferably 52 to 98 mol %, with respect to total moles of recurring units of precursor to Polymer (Iₓ) of recurring units derived from tetrafluoroethylene (TFE);
(2) 1 to 50% by moles, preferably 2 to 48% by moles, with respect to total moles of recurring units of precursor to Polymer (Iₓ), of recurring units derived from at least one monomer selected from the group consisting of:
(j) sulfonyl halide fluorovinylethers of formula: CF₂═CF—O—(CF₂)ₘSO₂Xₓ, with Xₓ being a halogen, preferably, F or Cl, more preferably F; wherein m is an integer from 1 to 10, preferably from 1 to 6, more preferably from 2 to 4, even more preferably m equals 2 or 4;
(jj) sulfonyl fluoride fluoroalkoxyvinylethers of formula: CF₂═CF—(OCF₂CF(R_{F1}))_{w}—O—CF₂(CF(R_{F2}))X_{X},
with X_{X} being a halogen, preferably, F or Cl, more preferably F; wherein w is 0, 1 or 2, R_{F1} and R_{F2}, equal or different from each other, are independently F, Cl or a C₁-C₁₀ fluoroalkyl group, optionally substituted with one or more ether oxygens, y is an integer from 0 to 6; preferably w is 1, R_{F1} is —CF₃, y is 1 and R_{F2} is F; and
(jjj) mixtures thereof; and
(3) 0 to 45 mol %, preferably 0 to 40 mol %, with respect to total moles of recurring units of precursor to Polymer (Iₓ), of recurring units derived from at least one hydrogenated and/or fluorinated monomer different from TFE, preferably a perfluorinated monomer, generally selected from the group consisting of hexafluoropropylene, perfluoroalkylvinylethers of formula CF₂═CFOR′_{f1}, wherein R′_{f1} is a C₁-C₆ perfluoroalkyl, e.g. —CF₃, —C₂F₅, —C₃F₇; perfluoro-oxyalkylvinylethers of formula CF₂═CFOR′_{O1}, wherein R′_{O1} is a C₂-C₁₂ perfluoro-oxyalkyl having one or more ether groups, including e.g. perfluoroalkyl-methoxy-vinylethers of formula CF₂═CFOCF₂OR′_{f2} in which R′_{f2} is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃.

According to certain embodiments, the preferred Polymer (Iₓ) consists essentially of, even consists of:
(k) 55 to 95 mol %, preferably 65 to 93 mol % of recurring units derived from TFE;
(kk) 5 to 45 mol %, preferably 7 to 35 mol % of hydrolysed recurring units comprising at least one —SO₃M group and derived from monomer(s) (2), as above detailed;
(kkk) 0 to 25 mol %, preferably 0 to 20 mol % of recurring units derived from fluorinated monomer(s) different from TFE (3), as above detailed, all percentages based on the total moles of recurring units of said Polymer (Iₓ).

Same holds true, mutatis mutandis, for preferred precursors, whereas units derived from monomer(s) (2), as above detailed are comprised, instead of their corresponding hydrolysed counterparts.

Polymer (Iₓ) and/or its precursor may further comprise recurring units derived from at least one bis-olefin [bis-olefin (OF)] of formula:

R_{A}R_{B}=CR_{C}-T-CR_{D}=R_{E}R_{F}

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group.

The bis-olefin (OF) is preferably selected from the group consisting of those of any of formulae (OF-1), (OF-2) and (OF-3):

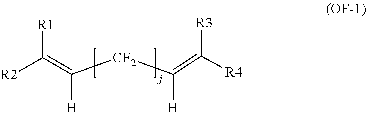

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

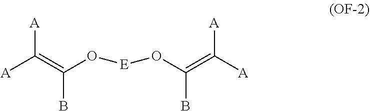

wherein each of A, equal to or different from each other and at each occurrence, is independently selected from the group consisting of H, F and Cl; each of B, equal to or different from each other and at each occurrence, is independently selected from the group consisting of H, F, Cl and ORB, wherein RB is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

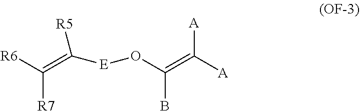

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

Should Polymer (Iₓ) or its precursor further comprise recurring units derived from at least one bis-olefin (OF), said Polymer (Iₓ) or its precursor typically comprise recurring units derived from the said at least one bis-olefin (OF) in an amount comprised between 0.01 and 1.0 mol %, preferably between 0.03% and 0.5 mol %, more preferably between 0.05 mol % and 0.2 mol %, based on the total moles of recurring units of Polymer (Iₓ) or its precursor, as the case may be.

The amount of said ionisable or hydrolysable groups in Polymer (Iₓ) or its precursor, as the case may be, are such to provide for an overall amount of ionisable or hydrolysable groups of at least 0.55, preferably at least 0.65, more preferably at least 0.75 meq/g, with respect to the total weight of Polymer (Iₓ) or its precursor, as the case may be.

There's no substantial limitation as per the maximum amount of the said ionisable or hydrolysable groups comprised in Polymer (Iₓ) or its precursor. It is generally understood that the said ionisable or hydrolysable groups are generally present in an amount of at most 3.50 meq/g, preferably at most 3.20 meq/g, more preferably at most 2.50 meq/g, with respect to the total weight of Polymer (Iₓ) or its precursor, as the case may be.

### the Polyamide-Imide Polymer, Polymer (PAI)

[Polymer (PAI)] which comprises recurring units, more than 50 mol % of said recurring units comprising at least one aromatic ring and at least one amic acid group and/or imide group [recurring units (R_{PAI})].

The recurring units (R_{PAI}) are advantageously selected from the group consisting of:

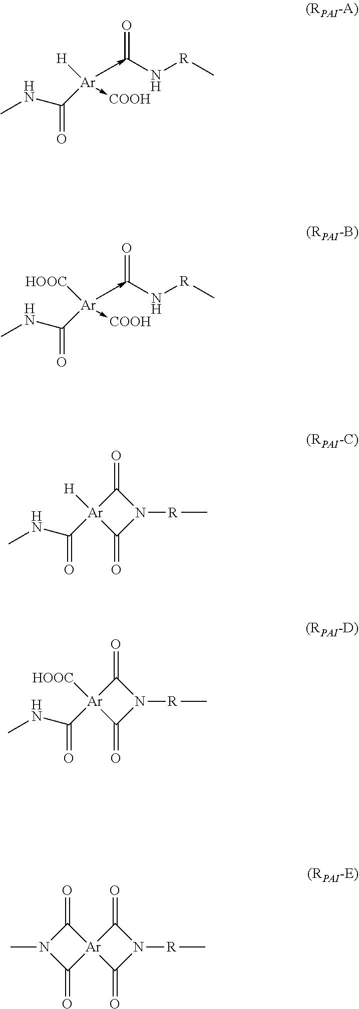

wherein:
the symbol → in each formula denotes isomerism so that, in any recurring unit within the aromatic polyamic acid structure, the groups to which the arrows point may exist either as shown or in an interchanged position;
Ar is an aromatic tetravalent group, which may comprise one or more than one aromatic ring, and which are preferably selected from the group consisting of:

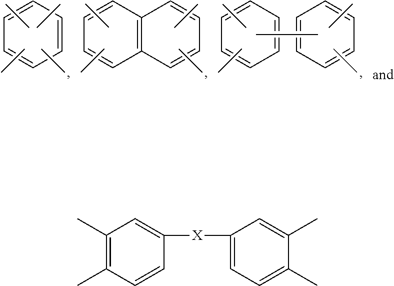

with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which are preferably selected from the group consisting of:

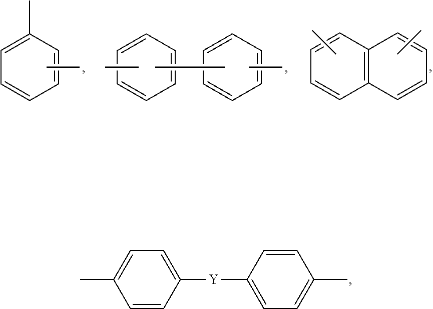

with Y being selected from the group consisting of —O—, —C(O)—, —S—, —SO₂—, —CH₂—, —C(CF₃)₂—, —(CF₂)ₙ— with n=0, 1, 2, 3, 4 or 5,

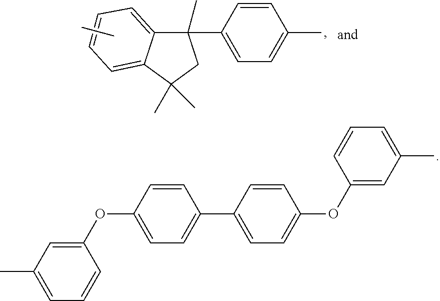

Recurring units (R_{PAI}) are more preferably chosen from the group consisting of units (i), (ii) and (iii), as below detailed:

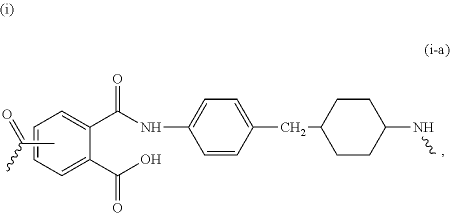

and/or the corresponding imide-group containing recurring unit:

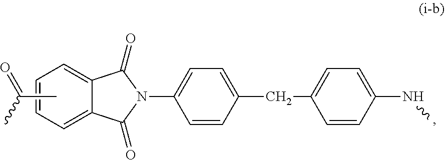

wherein the attachment of the two amide groups to the aromatic ring as shown in (i-a) will be understood to represent the 1,3 and the 1,4 polyamide-amic acid configurations;

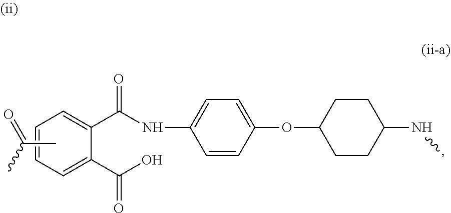

and/or the corresponding imide-group containing recurring unit:

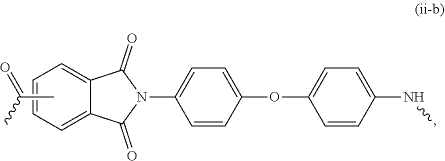

wherein the attachment of the two amide groups to the aromatic ring as shown in (ii-a) will be understood to represent the 1,3 and the 1,4 polyamide-amic acid configurations; and

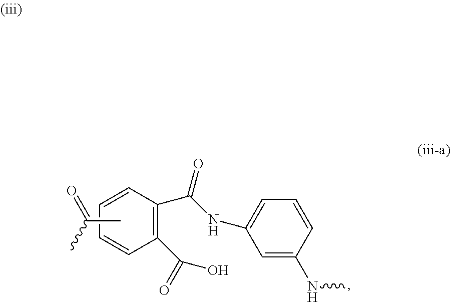

and/or the corresponding imide-group containing recurring unit:

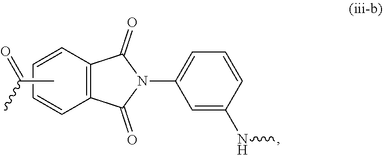

wherein the attachment of the two amide groups to the aromatic ring as shown in (iii-a) will be understood to represent the 1,3 and the 1,4 polyamide-amic acid configurations.

Recurring units (R_{PAI}) are preferably recurring units (i) or a mix of recurring units (ii) and (iii).

Preferably, Polymer (PAI) comprises more than 90 mol %, even more than 95 mol %, of recurring units (R_{PAI}). Still more preferably, it contains no recurring unit other than recurring units (R_{PAI}).

Excellent results were obtained with Polymer (PAI) consisting of recurring units (i) or of a mix of recurring units (ii) and (iii).

The amount of recurring units comprising amic group can be determined by any suitable technique, such as, notably spectroscopic techniques or titration techniques which are well known to those of ordinary skills in the art.

Typically, Polymer (PAI) contains no sulfonic acid groups.

When recurring units (R_{PAI}) are selected from those of formulae (R_{PAI}-A), (R_{PAI}-B), (R_{PAI}-C), (R_{PAI}-D), (R_{PAI}-E), as detailed above, the molar percentage of recurring units (R_{PAI}) comprising at least one amic acid group may be expressed as follows:

$$\frac{\{ [ ( {R}_{PAI} - A ) units ] + 2 \cdot [ ( {R}_{PAI} - B ) units ] + [ ( {R}_{PAI} - D ) units ] \}}{\begin{matrix}\{ [ ( {R}_{PAI} - A ) units ] + 2 \cdot [ ( {R}_{PAI} - B ) units ] + \\ [ ( {R}_{PAI} - C ) units ] + [ ( {R}_{PAI} - D ) units ] + [ ( {R}_{PAI} - E ) units ] \} \times 100\end{matrix}}$$

where [(R_{PAI}-A) units], [(R_{PAI}-B) units], [(R_{PAI}-C)units], [(R_{PAI}-D) units], and [(R_{PAI}-E) units] denote, respectively molar concentration of the different recurring units (R_{PAI}) as above described.

Typically no more than 70 mol %, even no more than 65 mol %, still no more than 60 mol % of recurring units (R_{PAI}) comprise at least one amic acid group.

Polymer (PAI) can be manufactured by a process including the polycondensation reaction between at least an aromatic polycarboxylic acid halide monomer and at least an aromatic diamine.

The aromatic polycarboxylic acid halide monomer is chosen from the group consisting of terephthaloyl chloride, isophthaloyl chloride, phthaloyl chloride, and the acid halide derivatives of trimellitic anhydride. Preferably it is selected from the trimellitic anhydride monoacid halides. Among the trimellitic anhydride monoacid halides, trimellitic anhydride monoacid chloride is preferred.

In some embodiments, a dicarboxylic anhydride monomer may be used in combination with the polycarboxylic acid halide monomer. Suitable dicarboxylic anhydride monomers include pyromellitic anhydride, bis(3,4-dicarboxyphenyl)ether dianhydride, and trimellitic anhydride. When a dicarboxylic anhydride monomer is used in the process, the excess of the acid halide monomer with respect to the equimolar concentration of the aromatic diamine monomer is calculated taking into consideration the combined moles of the acid halide and the dicarboxylic anhydride monomers.

The aromatic diamine monomer is selected from the group consisting of 4,4′-diaminodiphenyl ether (ODA), p-phenylenediamine, (PDA), m-phenylenediamine (MPDA), diphenyl dimethyl methane diamine (DMMDA), 1,3-bis(3-aminophenoxy) benzene (BAPB), 4,4′-bisphenol A ether diamine (BAPP), 4,4′-bis(4-aminophenoxy) diphenylsulfone (BAPS), 4,4′-bis(4-aminophenoxy) diphenyl ether (BAPE), diamino diphenyl (methyl) ketone (DABP), 4,4′-diamino-triphenylamine (DATPA), 4,4′-diaminodiphenyl methane (MDA), diaminodiphenyl sulfone (DDS), 3,4′-diaminodiphenyl ether (3,4′-ODA), 3,3′-dimethyl-4,4′-diamino diphenyl methane (MDI), 4,4′-diamino-diphenoxy-1″,4″-benzene, 4,4′-diamino-diphenoxy-1″,3″-benzene, 3,3′-diamino-diphenoxy-1″,3″-benzene, 4,4′-diamino-diphenyl-4″,4-phenyl-isopropyl propane.

The aromatic diamine monomer is preferably selected from the group consisting of 4,4′-diaminodiphenyl ether (ODA), p-phenylenediamine, (PDA), and m-phenylenediamine (MPDA) and mixtures thereof.

The polycondensation reaction is advantageously carried out under substantially anhydrous conditions in a polar solvent and at a temperature below 150° C., employing a stoichiometric excess of the acid halide monomer.

A monofunctional reactant can be employed as an endcapping agent as known to the skilled in the art to control the molecular weight and to improve stability of the polymer.

Polymer (PAI) is advantageously isolated in solid form under mild conditions, preferably by being coagulated or precipitated from the polar reaction solvent by adding a miscible non-solvent, for example water, a lower alkyl alcohol or the like. Optionally, the solid resin may then be collected and thoroughly washed with water, and centrifuged or pressed to further reduce the water content of the solid without applying heat. Non-solvents other than water and lower alkyl alcohols are known and have been used in the art for precipitating Polymer (PAI) from solution including, for example, ethers, aromatic hydrocarbons, ketones and the like.

The number average molecular weight (Mn) of Polymer (PAI) is advantageously at least 1000, preferably at least 1500, more preferably at least 2000.

The molecular weight of Polymer (PAI) (Mw and Mn) may be determined using gel permeation chromatography (GPC).

Non-limiting examples of suitable Polymers (PAI) are available under the trade name Torlon® PAI from Solvay Specialty Polymers.

### The Fiber

The fiber of the invention comprises Composition (C) as detailed above. In certain embodiments the fiber of the invention essentially consists of composition (C), wherein the expression essentially consist is used to indicate that the fiber contains less than 10 wt %, preferably less than 5 wt % of other components.

Non limiting examples of possible other components include for instance the solvent used in the preparation of the fiber or any other additive used to facilitate the production of the fiber.

The fiber may have a diameter (or similar cross-sectional dimension for non-circular shapes) of 50 to 1500 nm. Typically the fiber has a diameter of at least 80 nm, preferably at least 100 nm. The fiber diameter is generally less than 1500 nm, even less than 1200 nm. For instance 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 nm.

The fiber of the invention may be of a range of lengths based on aspect ratios of at least 100, 500, 1000, 5000 or higher relative to the fiber diameter. In one embodiment, the length of the fiber may be of at least 0.5 micrometer, even at least 1.0 micrometer, including lengths in the range of about 0.5 micrometers to 10 meters, or more. Additionally, the fiber may be cut to a desired length using any suitable instrument.

### Method for Making the Fiber

The fiber can be advantageously obtained by means of an electrospinning or a forcespinning process. Both processes are known in the art for the preparation of fibers. Fibers resulting from these processes may be used to create webs, for instance nonwoven webs, from an accumulation of fibers.

The typical electrospinning setup includes: a high-voltage source connected to an outlet port that is coupled to a source of a fluid fiber-forming material. An electrical field is created so as to charge the outlet port where the fluid exits. Electrodes for focusing, steering, and guiding the exiting solutions are positioned below the outlet port. These help guide/draw the fluid into a fiber from the outlet port and onto the collector.

Forcespinning is also a known technique The fibers may be produced using forced ejection of a selected starting fiber-forming, fluid material through an outlet port. The outlet port is configured with a size and shape to cause a fine jet of the fluid material to form on exit from the outlet port. Due to factors such as surface tension, fluid viscosity, solvent volatility, rotational speed, and others, the ejected material can solidify as a superfine fiber that has a diameter significantly less than the inner diameter of the outlet port. The jet of expelled material is directed to a collector, where it is gathered for use in an end product.

Regardless of the technique used, whether electrospinning or forcespinning, the collected fiber material forms a web of two- or three-dimensional entangled fibers that can be worked to a desired surface area and thickness. Surface area and thickness may be controlled with the amount of time fibers continue to be expelled onto a collector, and control over the surface area of the collector (e.g., a moving belt as a collector can allow for sheets of material of unlimited length).

As the superfine fibers are laid upon each other, contacts points are made at intersections, and the membrane consistently binds together. If any web-bonding of the contact points is desired, it may be accomplished via application of heat (thermal bonding), heat and pressure, and/or chemical bonding. The system may include heating elements, pressure applicators, and chemical bonding units for achieving such bonding.

In some embodiments, the fiber-forming material is fed into a reservoir as a polymer solution, i.e., Composition (C) dissolved in an appropriate solvent. In this embodiment, the method may further comprise dissolving or dispersing Polymer (Iₓ), Polymer (PAI) and optionally a stabilizing additive, in a solvent prior to feeding the fiber-forming material into the reservoir.

The liquid composition may advantageously be prepared by a dissolution process wherein Polymer (Iₓ), Polymer (PAI) and optionally a stabilizing additive are contacted with a liquid medium under suitable temperature conditions.

Suitable liquid media that can be used are polar aprotic organic solvents such as ketones, like acetone, methylethylketone, esters, like methylacetate, dimethylcarbonate, diethylcarbonate, ethylacetate, nitriles, like acetonitrile, sulphoxides, like dimethylsulfoxide, amides, like N,N-dimethylformamide, N,N-dimethylacetamide, pyrrolidones, like N-methylpyrrolidone, N-ethylpyrrolidone.

In other embodiments, Composition (C) is fed into the reservoir as a polymer melt. In such embodiment, the reservoir is heated to a temperature suitable for melting or softening Polymer (Iₓ) and Polymer (PAI).

At the end of the electrospinning or forcespinning process, a plurality of polymeric fibers are formed. The plurality of fibers may be of the same diameter or of different diameters.

The fibers are typically randomly arranged to constitute a fiber assembly, hereinafter referred to as a “web”. In the present specification the term “mat” may also be used to refer to the assembly of fibers.

The thickness of the fiber web as produced from the electrospinning or forcespinning process may need to be adjusted by pressing the web in a calendaring roller or other pressing apparatus, and this pressing operation may be carried out at a temperature that may result in some fusion of fibers at contact points, depending on the material used.

Typically, the temperature is kept below the melting point of the fiber material. Contact points, if fused together, may provide some amount of reinforcement when the fiber web is used in the preparation of an ion exchange membrane.

### The Composite Membrane

Advantageously assemblies comprising the inventive fibers can be used in the preparation of composite membranes. Composite membranes can be used both as ion exchange membranes in electrolytic cells or as membranes for filtration or ultrafiltration applications.

The term “membrane” is used herein in its usual meaning to indicate a discrete, generally thin, interface that moderates the permeation of chemical species in contact with it.

The expression “composite membrane” is used herein to refer to membrane comprising the inventive fibers, for instance a web of the inventive fibers, and an ion exchange polymer.

The composite membrane typically comprises a first phase comprising, preferably consisting of, the ion exchange polymer and a second phase comprising composition (C). The first and second phase may be layers in a multilayer structure. The composite membrane may comprise more than one phase of the first type and/or more than one phase of the second type.

The composite membrane may comprise the fibers distributed in a matrix of the ion exchange polymer. The fibers may be loose fibers, that is fibers that are not arranged in a web. The fibers may be chopped.

The composite membrane can be manufactured by a process comprising: (a) providing a plurality of the inventive fibers; and (b) mixing the plurality of fibers with a polymer comprising a plurality of ion exchange groups. Mixing can be performed, for instance, by providing the fibers to a dispersion of the polymer comprising a plurality of ion exchange groups in a liquid.

Alternatively, the composite membrane may comprise a web made of the inventive fibers and an ion exchange polymer.

The ion exchange polymer is applied on the web of fibers. Any conventional method known in the art, such as impregnation, casting, coating, e.g. roller coating, gravure coating, reverse roll coating, dip coating, spray coating and the like may be used to apply the ion exchange polymer to the web of fibers.

Coating may be done by standard techniques known in the art, including casting, notch bar coating, or lamination.

Alternatively the composite membrane may be prepared with an impregnation process. Such an impregnation process comprises the step of impregnating the web of inventive fibers with a liquid composition comprising an ion exchange polymer.

Impregnation can be carried out by immersion of the web of fibers into an impregnation vessel comprising the liquid composition or it can be performed by applying suitable amounts of the same by well-known coating techniques such as casting, coating, spraying, brushing and the like, either simultaneously on each side of the porous support or in subsequent coating steps. It is nevertheless generally understood that impregnation by immersion in a vessel comprising the liquid composition is the technique having provided best results.

The process for preparing the composite membrane typically comprises at least one drying step and/or at least one annealing step.

The drying step is typically intended to remove excess liquid medium from the film of ion exchange polymer. This step is generally carried out at a temperature of from 20 to 100° C., preferably from 25 to 90° C., more preferably from 30 to 80° C.

The annealing step, typically conceived for consolidating the film of ion exchange polymer, is generally carried out at a temperature of at least 150° C., preferably of at least 170° C., more preferably of at least 180° C., and even more preferably of at least 200° C. Maximum temperature is not particularly limited, provided that the inventive web of fibers and the ion exchange polymer remain stable under these conditions. Generally the annealing step is carried out at a temperature not exceeding 300° C., preferably not exceeding 270° C., more preferably not exceeding 250° C.

The ion exchange polymer may be any polymer comprising ion exchange groups.

The ion exchange polymer may advantageously be a fluorinated ion exchange Polymer (Iₓ). All the definitions and preferences detailed above for Polymer (Iₓ) when used for the preparation of the inventive fibers equally apply to Polymer (Iₓ) when used for the preparation of the composite membrane.

The Polymer (Iₓ) used in the preparation of the membrane may be the same or different from the Polymer (Iₓ) used in Composition (C) for the preparation of the fibers. For instance the polymer may comprise the same recurring units but in different relative proportions or it may comprise different recurring units.

The composite membrane of the invention has superior proton conductivity even at low relative humidity and thus exhibits improved performance when used as a polymer electrolyte membrane in a membrane-electrode assembly for fuel cells.

In accordance with another embodiment of the present invention, there is provided a membrane-electrode assembly for fuel cells comprising the ion-exchange composite membrane as a polymer electrolyte membrane and a fuel cell comprising the same.

Specifically, the membrane-electrode assembly includes an anode and a cathode which face each other, and the composite membrane as a polymer electrolyte membrane disposed between the anode and the cathode.

The membrane-electrode assembly may be produced by a general method for manufacturing a membrane-electrode assembly for fuel cells except that the composite membrane is used as a polymer electrolyte membrane.

In accordance with another embodiment of the present invention, there is provided a fuel cell including a membrane-electrode assembly including the composite membrane as a polymer electrolyte membrane.

The composite membrane of the invention may also be used in filtration or ultrafiltration devices. Accordingly a further object of the invention is a filtration or ultrafiltration device comprising the composite membrane of the invention.

Should the disclosure of any of the patents, patent applications, and publications that are incorporated herein by reference conflict with the present description to the extent that it might render a term unclear, the present description shall take precedence.

The invention will be illustrated by means of the following non-limiting examples.

### EXAMPLES

The following materials were used in the following examples:

Ix-1: Aquivion® PFSA PW98, Tetrafluoroethylene-perfluoro(3-oxa-4-pentenesulfonic acid) copolymer having eq. wt. 980 g/mole SO₃H, available from Solvay Specialty Polymers

PAI-1: Torlon® AI-10 LM is a polyamide-imide polymer with an acid number of 82.0 mg KOH/g available from Solvay Specialty Polymers

### Comparative Ex 1: Preparation of Forcespun Fibers and Web of Polymer PAI

PAI-1 was dried in a vent oven at 170° C. After 4h, PAI-1 was dissolved in dimethylacetamide under stirring and at room temperature. The dispersion was forcespun using a FibeRio Cyclone FE using a spinneret rotating, equipped with a nozzle of 150-500 micron. Forcespun fibers were arranged into a web having a thickness of 30 micron and a grammage of 3 g/m².

### Example 1: Preparation of Forcespun Fibers of Polymer (Iₓ) and Polymer PAI

PAI-1 was dried in a vent oven at 170° C. whereas Ix-1 was dried in a vent oven at 100° C. After 4h, PAI-1 and Ix-1 were dissolved in dimethylacetamide under stirring and at room temperature to provide a dispersion containing 10 wt % of Ix-1 and 90 wt % of PAI-1 with respect to the total amount of polymers.

The dispersion was forcespun using a FibeRio Cyclone FE using a spinneret rotating at 6000-8000 rpm, equipped with a nozzle of 150-500 microns. Forcespun fibers were arranged into a web having a thickness of 40 micron and a grammage of 5.8 g/m².

### Example 2 and Comp. Example 2: Composite Membrane Preparation

The webs consisting of the forcespun fibers obtained in Example 1 and Comp. Example 1 were used for the preparation of composite membranes. Each web was mounted on a PTFE circular frame having an internal diameter of 100 mm and then was immersed in a liquid mixture containing polymer Ix-1 (14 wt %), water (42 wt %), 1-propanol (34 wt %) and N-ethylpyrrolidone (10 wt %) at room temperature for 2 min. The specimen was then heat treated in a vent oven at 65° C. for 1 h, at 90° C. for 1 h and from 90° C. to 190° C. in 1 h. The thickness of resulting membranes was 50±5 micron. The weight ratio of fibers into the final membrane was about 1.7 wt %.

### Characterization of Composite Membranes

In-plane conductivity was measured through a four-electrode Bekk-Tech BT-112 cell working at 80° C. and within a relative humidity range between 20 and 120%. Humidified hydrogen (1000 scan) and heating were supplied using a 1 KW Greenlight Power Technologies FCATS-E fuel cell test station. Membrane conductivity was calculated considering the geometrical parameters of the samples and the cell resistance obtained as the slope of the cell voltage vs. current plot using a Metrohm Autolab PGSTAT-30 potentiostat/galvanostat. The cell was conditioned at the working temperature for 1 h prior the measurements.

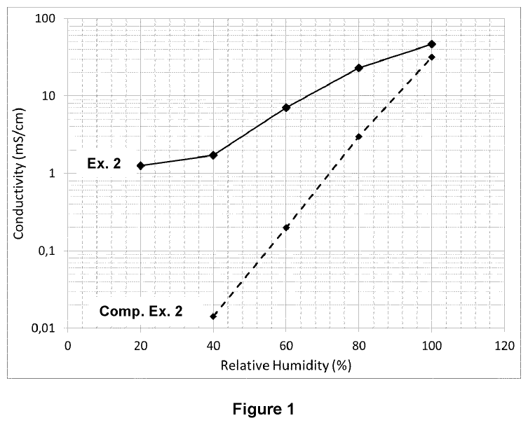

Results shown in FIG. 1 indicate that the composite membrane obtained using as a reinforcement layer the web of fibers made of the inventive composition (Example 2) has a much higher proton conductivity than the composite membrane obtained with the web of Comparative Example 2 across all ranges of relative humidity and, in particular, at low values of relative humidity.

1. A fiber comprising a composition, [Composition (C)], comprising at least one fluorinated polymer comprising a plurality of ion exchange groups or a precursor thereof, [Polymer (Iₓ)], and at least one aromatic polyamide-imide polymer, [Polymer (PAI)].

2. The fiber according to claim 1 which comprises 0.1 to 95.0 wt %, of the at least one Polymer (Iₓ) and 5.0 to 99.9 wt % of the at least one Polymer (PAI) with respect to a total weight of the Composition (C).

3. The fiber of claim 1 wherein Polymer (Iₓ) is selected from the group consisting of polymers comprising:
(1) 50 to 99 mol % with respect to total moles of recurring units of Polymer (Iₓ), of recurring units derived from tetrafluoroethylene;
(2) 1 to 50 mol % with respect to total moles of recurring units of Polymer (Iₓ), of at least one monomer comprising at least one —SO₂X group wherein X is a halogen or —OM wherein M is selected from the group consisting of H, an ammonium group or a metal selected from the group consisting of:
(j) sulfonyl halide fluorovinylethers of formula: CF₂═CF—O—(CF₂)ₘSO₂X wherein m is an integer from 1 to 10;
(jj) sulfonyl fluoride fluoroalkoxyvinylethers of formula: CF₂═CF—(OCF₂CF(R_{F1}))_{w}—O—CF₂(CF(R_{F2}))_{y}SO₂X wherein w is an integer from 0 to 2, R_{F1} and R_{F2}, equal or different from each other, are independently F, Cl or a C₁-C₁₀ fluoroalkyl group, optionally substituted with one or more ether oxygens, y is an integer from 0 to 6; and
(jjj) mixtures thereof; and
(3) 0 to 45 mol % with respect to total moles of recurring units of Polymer (Iₓ), of recurring units derived from at least one hydrogenated and/or fluorinated monomer different from TFE, selected from the group consisting of hexafluoropropylene, perfluoroalkylvinylethers of formula CF₂═CFOR′_{f1}, wherein R′_{f1} is a C₁-C₆ perfluoroalkyl; perfluoro-oxyalkylvinylethers of formula CF₂═CFOR′_{O1}, wherein R′_{O1} is a C₂-C₁₂ perfluoro-oxyalkyl having one or more ether groups, including perfluoroalkyl-methoxy-vinylethers of formula CF₂═CFOCF₂OR′_{f2} in which R′_{f2} is a C₁-C₆ perfluoroalkyl, or a C₁-C₆ perfluorooxyalkyl having one or more ether groups.

4. The fiber of claim 1 wherein Polymer (PAI) comprises recurring units, more than 50 mol % of said recurring units comprising at least one aromatic ring and at least one amic acid group and/or imide group [recurring units (R_{Pai})] which are selected from the group consisting of: 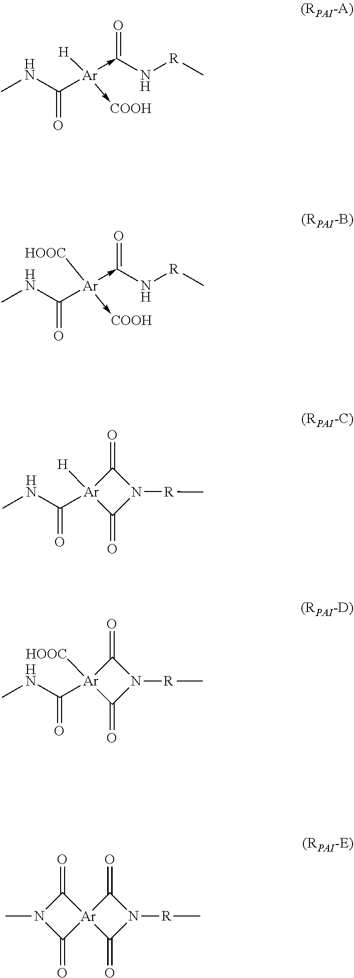
wherein:
the symbol → in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which are preferably selected from the group consisting of: 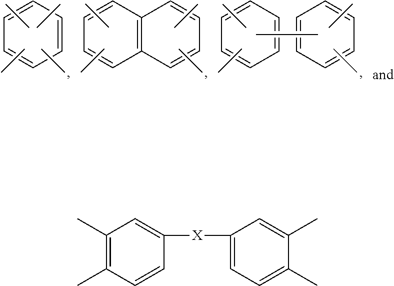
with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which are preferably selected from the group consisting of: 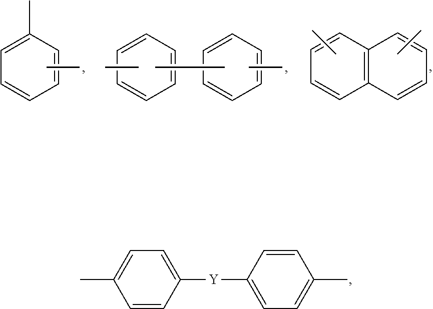
with Y being selected from the group consisting of —O—, —C(O)—, —S—, —SO₂—, —CH₂—, —C(CF₃)₂—, —(CF₂)ₙ— with n=0, 1, 2, 3, 4 or 5,

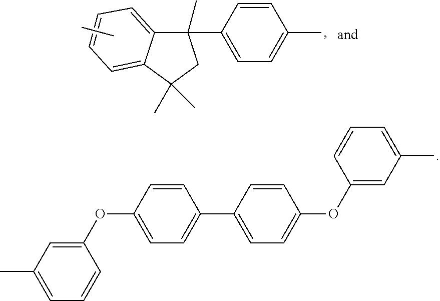

5. The fiber according to claim 1 comprising, with respect to a total weight of the composition, 1.0 wt % to 50.0 wt %, of the at least one Polymer (Iₓ), 50.0 to 99.0 wt % of the at least one Polymer (PAI), and optionally 0.01 to 5.0 wt % of a stabilizing additive selected from the group consisting of the oxides of cerium and manganese, CeO₂, Ce₂O₃ and MnO₂, alone or in combination with other oxides, and of the salts of cerium and manganese.

6. (canceled)

7. An assembly in the form of a web, comprising a plurality of fibers of claim 1.

8. A process for the preparation of the fiber of claim 1 comprising the step of electrospinning or force spinning the Composition (C) through a spinneret.

9. (canceled)

10. (canceled)

11. A composite membrane comprising a plurality of fibers of claim 1 and a polymer comprising a plurality of ion exchange groups.

12. A composite membrane comprising the fiber assembly of claim 7 and a polymer comprising a plurality of ion exchange groups.

13. (canceled)

14. A method of making the composite membrane of claim 11 comprising: (a) providing the plurality of fibers; and (b) mixing the plurality of fibers with a polymer comprising a plurality of ion exchange groups.

15. A method of making the composite membrane of claim 11, comprising: (a) providing an assembly in the form of a web of fibers; and (b) applying the polymer comprising a plurality of ion exchange groups on the web of fibers.

16. The method of claim 15 in which the polymer comprising a plurality of ion exchange groups is applied to the web of fibers by impregnation, casting or coating.

17. (canceled)

18. A membrane-electrode assembly comprising the composite membrane of claim 11.

19. A fuel cell comprising the composite membrane of claim 11.

20. A filtration or ultrafiltration device comprising the composite membrane of claim 11.

21. The fiber according to claim 2 which comprises 0.5 to 75.0 wt % of the at least one Polymer (Iₓ) and 25.0 to 99.5 wt % of the at least one Polymer (PAI) with respect to the total weight of the Composition (C).

22. A membrane-electrode assembly comprising the composite membrane of claim 12.

23. The fiber of claim 3, wherein w is 1, R_{F1} is —CF₃, y is 1 and R_{F2} is F.

24. A fuel cell comprising the membrane-electrode assembly of claim 18.

25. A filtration or ultrafiltration device comprising the composite membrane of claim 12.
